(19) United States
(12) Patent Application Publication
(10) Pub. No.: US 2020/0328770 A1
(43) Pub. Date: Oct. 15, 2020

(54) ANTI-RADIATION MOBILE PHONE CASE

(71) Applicant: Qichun SHE, shenzhen (CN)

(72) Inventor: Qichun SHE, shenzhen (CN)

(21) Appl. No.: 16/583,196

(22) Filed: Sep. 25, 2019

(30) Foreign Application Priority Data
Apr. 12, 2019 (CN) 201920507803.4
Aug. 13, 2019 (CN) 201921314341.0

(51) Int. Cl. H04B 1/3827; H04M 1/02

(52) U.S. Cl. CPC H04B 1/3838; H04M 1/0202

(57) ABSTRACT

The present disclosure provides an anti-radiation mobile phone case, including a main body and a first absorbing member. The main body is provided with a body plate and a flange disposed at a periphery of the body plate, and the body plate is enclosed with the flange to form a receiving cavity. The first absorbing member is attached onto an inner side wall of the flange, and a space of the body plate corresponding to the first absorbing member is reserved. The first absorbing member is a single layer structure made of wave absorbing and shielding material, or a multilayer composite structure made of at least one layer of wave absorbing and shielding material.

### CROSS REFERENCE TO RELATED APPLICATIONS

The present disclosure claims the priority of Chinese Patent Application No. 201920507803.4 filed on Apr. 12, 2019 and entitled “anti-radiation mobile phone case” and claims a part of the priority of Chinese Patent Application No. 201921314341.0 filed on Aug. 13, 2019 and entitled “mobile phone case”, which are incorporated herein by reference in its entirety.

### TECHNICAL FIELD

The present disclosure relates to the technical field of mobile phone accessories, in particular to, an anti-radiation mobile phone case.

### BACKGROUND

The statements herein merely provide background information related to the present disclosure and do not necessarily constitute prior art.

The mobile phone is typically close to the user's head when used for communication. As electromagnetic radiation pollution is generated during the communication, the user using the mobile phone may be vulnerable to various diseases, if exposed to such pollution with a close distance for a long time.

In practical communication, anti-radiation mobile phone case with a full covering is mostly provided for mobile phones, in order to prevent the radiation to the user. However, signal receiving would thus be negatively affected and the radiation proof is not unsatisfactory.

### SUMMARY

The main purpose of the present disclosure is to provide an anti-radiation mobile phone case, which aims to prevent the anti-radiation mobile phone case from affecting the signal receiving to attenuate the signal radiation of the mobile phone.

In order to achieve the above objective, the present disclosure provides an anti-radiation mobile phone case, which includes:

a main body, the main body is provided with a body plate and a flange disposed at a periphery of the body plate, and the body plate is enclosed with the flange to form a receiving cavity; and

a first absorbing member, the first absorbing member is attached onto an inner side wall of the flange, and a space of the body plate corresponding to the first absorbing member is reserved;

the first absorbing member is a single layer structure made of wave absorbing and shielding material, or a multilayer composite structure made of at least one layer of wave absorbing and shielding material.

Optionally, the mobile phone case further includes an antenna hole, and the antenna hole is penetrated from an outer wall of the receiving cavity to an inner wall of the receiving cavity.

Optionally, an opening area of the antenna hole on the outer wall of the receiving cavity is larger than an opening area of the antenna hole on the inner wall of the receiving cavity.

Optionally, a wall of the antenna hole is curved.

Optionally, the first absorbing member corresponding to an area of the antenna hole is provided with a through hole.

Optionally, the first absorbing member is mixed with a fragrance.

Optionally, an outer surface of the first absorbing member is sprayed with a rubber oil layer.

Optionally, the first absorbing member is disposed along a bending direction of the flange.

Optionally, the anti-radiation mobile phone case includes a microwave transmitting layer covering the body plate and positioned in the receiving cavity; or

the microwave transmitting layer is configured to cover a reserved space for the first absorbing member.

Optionally, an extending portion is disposed on a side of the first absorbing member away from the body plate, and an angle θ is formed between the extending portion and the body plate, and the angle θ ranges from at least 20° to at most 75°.

Optionally, a first insulating layer is attached to an inner sidewall of the extending portion.

Optionally, the first absorbing member has a thickness of at least 0.2 mm to at most 2 mm.

Optionally, the anti-radiation mobile phone case further includes a cover, the cover is rotatably connected to the main body, and the cover is disposed to open or close the receiving cavity.

Optionally, the anti-radiation mobile phone case further includes a second absorbing member attached to a surface of the cover facing the receiving cavity.

Optionally, a display window is disposed on the cover.

Optionally, a side of the second absorbing member away from the cover is attached by a second insulating layer.

In the present disclosure, the anti-radiation mobile phone case includes a main body and a first absorbing member. The main body is provided with a body plate and a flange disposed at a periphery of the body plate, and the body plate is enclosed with the flange to form a receiving cavity. The first absorbing member is attached to an inner side wall of the flange, and a space of the body plate corresponding to the first absorbing member is reserved. The first absorbing member is a single layer structure made of wave absorbing and shielding material, or a multilayer composite structure made of at least one layer of wave absorbing and shielding material. The present disclosure can ensure the normal communication of the mobile phone, and can effectively attenuate the radiation generated by the mobile phone during the poor signal strength or the communication.

### BRIEF DESCRIPTION OF THE DRAWINGS

FIG. 1 is a schematic structural view of an anti-radiation mobile phone case according to an embodiment of the present disclosure;

FIG. 2 is a schematic exploded structural view of the anti-radiation mobile phone case of FIG. 1;

FIG. 3 is a schematic structural diagram of a mobile phone case according to another embodiment of the present disclosure;

FIG. 4 is a schematic structural diagram of a mobile phone case according to yet another embodiment of the present disclosure;

FIG. 5 is a schematic structural diagram of an antenna hole according to an embodiment of the present disclosure;

FIG. 6 is a schematic structural diagram of a first absorbing member according to an embodiment of the present disclosure;

FIG. 7 is a schematic exploded structural view of the anti-radiation mobile phone case according to an embodiment of the present disclosure;

FIG. 8 is a schematic exploded structural view of the anti-radiation mobile phone case according to another embodiment of the present disclosure;

FIG. 9 is a schematic exploded structural view of the anti-radiation mobile phone case according to yet another embodiment of the present disclosure;

FIG. 10 is a schematic structural view of the anti-radiation mobile phone case in FIG. 9 displayed from another direction; and

FIG. 11 is a cross sectional view of the anti-radiation mobile phone case in FIG. 10 taken along the line A-A.

The realization of the objective, functional characteristics, advantages of the present disclosure are further described with reference to the accompanying drawings.

### DETAILED DESCRIPTION OF THE EMBODIMENTS

The technical solutions in the embodiments of the present disclosure will be clearly and completely described in the following with reference to the accompanying drawings. It is obvious that the described embodiments are merely a part of the embodiments of the present disclosure, and not all of the embodiments. All other embodiments obtained by the ordinary person skilled in the art based on the embodiments of the present disclosure without creative efforts shall fall within the protection scope of the present disclosure.

It should be noted that all directional indications (such as upper, lower, left, right, front, rear) in the embodiments of the present disclosure are only used to explain the relative positional relationship, motion, and the like between the components in a certain posture (as shown in the drawings). If the certain posture changes, the directional indication also changes accordingly.

Besides, the descriptions of “first”, “second” and the like in the present disclosure are merely used for description, and are not to be construed as indicating or implying their relative importance or implicitly indicating a number of technical features indicated. Thus, the features defining “first” or “second” may include at least one of the features, either explicitly or implicitly. In addition, the technical solutions between the various embodiments may be combined with each other, but which shall be able to be implemented by the ordinary person skilled in the art. When the combination of the technical solutions is contradictory or impossible to be achieved, it should be considered that the combination of such technical solutions does not exist and is not within the protection scope of the present disclosure.

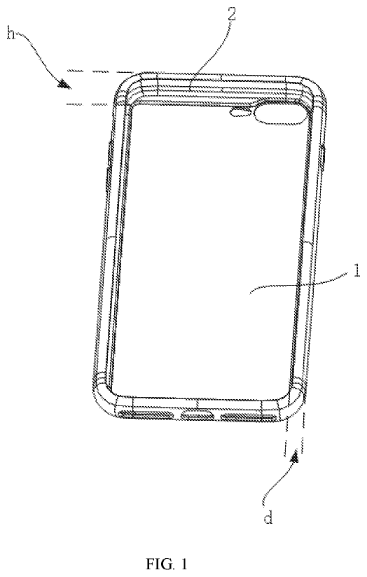

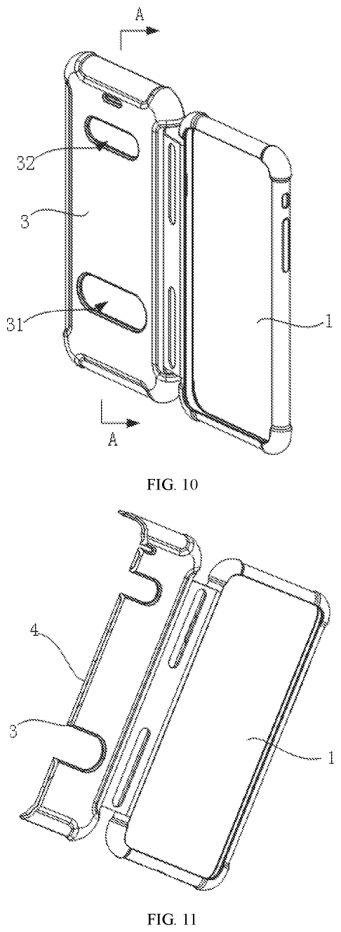

As shown in FIG. 1 to FIG. 11, the present disclosure provides an anti-radiation mobile phone case.

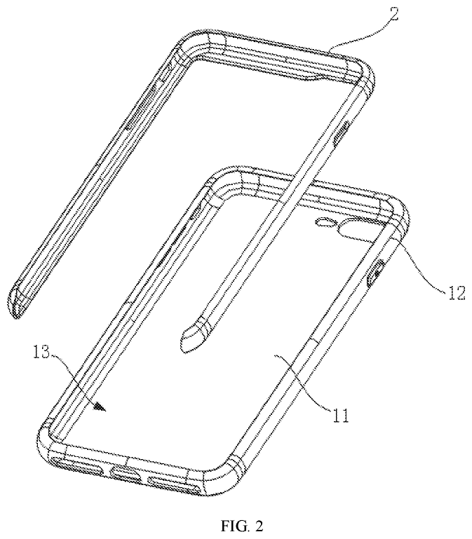

In an embodiment, as shown in FIG. 1 and FIG. 2, the anti-radiation mobile phone case includes a main body 1 and a first absorbing member 2. The main body 1 is provided with a body plate 11 and a flange 12 disposed at a periphery of the body plate 11, and the body plate 11 is enclosed with the flange 12 to form a receiving cavity 13. The receiving cavity 13 is configured to receive a mobile phone product, and the receiving cavity 13 is matched with the shape and size of the mobile phone product. For example, the receiving cavity 13 is provided with a through hole or a groove at a position of a speaker, a power button, a camera, a volume button and the like of the mobile phone product, so as to match the realization of the corresponding functions of the mobile phone product.

It can be understood that the mobile phone product can be a mobile phone equipped with an IOS system, an Android system or other systems. The size of the receiving cavity 13 is determined according to the model or type of the mobile phone product, and the specific size is set according to the specific model or type, and is not limited herein.

The main body 1 is made of a lightweight elastic material such as plastic, rubber or tempered glass. The body plate 11 may be disposed integrally with the flange 12, for example, the body plate 11 is integrally injection molded or extrusion molded with the flange 12. It is obvious that, in other embodiments, the body plate 11 may also be disposed separately with the flange 12, the flange 12 is attached to the periphery of the body plate 11 through an adhesive glue, and the adhesive glue includes, but is not limited to, glue, super glue, and the like, and is not limited herein.

In an embodiment, the first absorbing member 2 is attached onto an inner side wall of the flange 12, and a space of the body plate 11 corresponding to the first absorbing member 2 is reserved. The first absorbing member 2 is a single layer structure made of wave absorbing and shielding material, or a multilayer composite structure made of at least one layer of wave absorbing and shielding material. The case 1 is configured to support the first absorbing member 2, and in another embodiment, the mobile phone product may be directly disposed in the first absorbing member 2 without using the case 1. The outer side of the first absorbing member 2 is covered with a protective sleeve made of silicone or rubber, and the back of the mobile phone product can be reserved to maintain normal communication of the mobile phone and absorb radiation generated from the side of the mobile phone product.

Optionally, the flange 12 is an inner buckle type structure, that is, the first absorbing member 2 is attached and fastened to the inner side wall of the flange 12. In order to ensure the stability of the connection between the first absorbing member 2 and the flange 12, the first absorbing member 2 and the flange 12 may be pasted using a double-sided adhesive tape with a good adhesion, to avoid that the first absorbing member 2 is easily detached from the flange 12 during the use of the anti-radiation mobile phone case. It is obvious that in other embodiments, the first absorbing member 2 may also be connected with the flange 12 by other ways, such as glue or the like, which is not limited herein.

The space of the body plate 11 corresponding to the first absorbing member 2 is reserved. That is, when the mobile phone product is installed in the first absorbing member 2, the first absorbing member 2 is reserved with respect to the back of the mobile phone product, to prevent the communication signal of the mobile phone product from being blocked, thereby maintaining the normal communication signal of the mobile phone product. Besides, since the first absorbing member 2 is made of a wave absorbing and shielding material, that is, the first absorbing member 2 is configured to absorb the radiation generated by the mobile phone product during the poor signal strength or the communication. The first absorbing member 2 may absorb radiation from the side of the mobile phone product when the first absorbing member 2 is attached to the inner side wall of the flange 12. Since the first absorbing member 2 is reserved with respect to the back of the mobile phone product, the normal communication of the mobile phone product is not affected, thereby effectively attenuating the radiation generated by the mobile phone product during the poor signal strength or the communication.

Optionally, a reserved space of the first absorbing member 2 may be a combination of one or more regular shapes and irregular shapes. For example, the reserved space may be a combination of one or more of a regular square, a regular circular arc, a regular circular shape, or a regular N-sided shape (N is a positive integer greater than or equal to 3). The reserved space may also be a combination of one or more of an irregular square, an irregular circular arc, an irregular circular shape, an irregular N-sided shape (N is a positive integer greater than or equal to 3), and the like, and is not limited thereto.

Optionally, the radiation from the back of the mobile phone will still divergent towards the user's brain during the conversation when the area where the reserved space is positioned is too large; the communication signal of the mobile phone is attenuated and the radiation intensity of the mobile phone is increased when the area where the reserved space is positioned is too small. As shown in FIG. 1, the distance of the reserved space of the first absorbing member 2 from the longer side of the body plate 11 is d, and d is less than 10 mm; the distance of the reserved space of the first absorbing member 2 from the side of the top end of the body plate 11 is h, and h is greater than 8 mm and less than 50 mm. In this embodiment, the value of d is 3 mm, and the value of h is 20 mm.

In other embodiments, the values of d and h may be other values based on the above-mentioned range of values, and are not limited herein.

It will be understood that the embodiment does not limit the shape of the reserved space. In other embodiments, only the shape of the reserved space is changed to achieve effective attenuation of the radiation generated by the mobile phone product while maintaining normal communication of the mobile phone product, which is considered to be within the protection scope of the present disclosure.

Optionally, the wave absorbing and shielding material may be one or more of a magnetic wave absorbing and shielding material, a metal powder wave absorbing and shielding material, a liquid alloy wave absorbing and shielding material, a composite fiber wave absorbing and shielding material, a composite rubber wave absorbing and shielding material, a composite silicone wave absorbing and shielding material, a composite resin wave absorbing and shielding material, or a composite foam wave absorbing and shielding material.

Taking the wave absorbing and shielding material as a composite silicone wave absorbing and shielding material as an example, the composite silicone wave absorbing and shielding material includes wave absorbing agent: iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder (nickel copper powder copper trichloride polymer powder), or liquid alloy powder, etc. Based on the above composite silicone wave absorbing and shielding material, the first absorbing member 2 is a single layer structure made of one of iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder, or liquid alloy powder.

Optionally, based on the above composite silicone wave absorbing and shielding material, the first absorbing member 2 is a multilayer composite structure made of at least one of iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder, or liquid alloy powder.

It can be understood that, in other embodiments, the first absorbing member 2 may be prepared by other wave absorbing and shielding material except the above composite silicone wave absorbing and shielding material, and details are not described herein again.

In the embodiments of the present disclosure, the anti-radiation mobile phone case includes a main body 1 and a first absorbing member 2. The main body 1 is provided with a body plate 11 and a flange 12 disposed at a periphery of the body plate 11, and the body plate 11 is enclosed with the flange 12 to form a receiving cavity 13. The first absorbing member 2 is attached to an inner side wall of the flange 12, and a space of the body plate corresponding to the first absorbing member is reserved. The first absorbing member 2 is a single layer structure made of wave absorbing and shielding material, or a multilayer composite structure made of at least one layer of wave absorbing and shielding material. As such, in the technical solution of the present disclosure, the first absorbing member 2 is configured to absorb the radiation and the space of the first absorbing member is reserved, to ensure normal communication of the mobile phone, thereby effectively attenuating the radiation generated by the mobile phone during the poor signal strength or the communication.

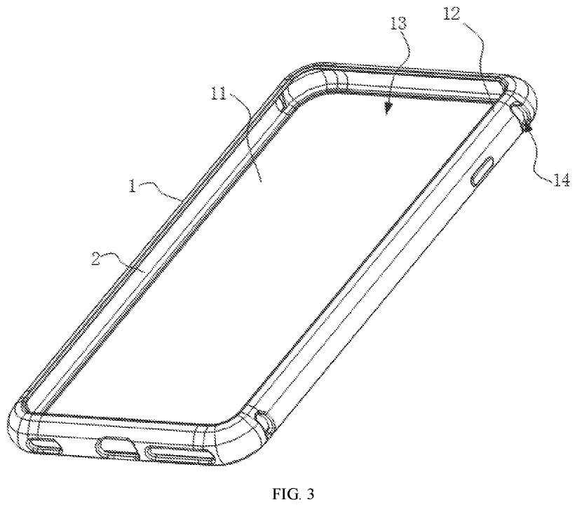

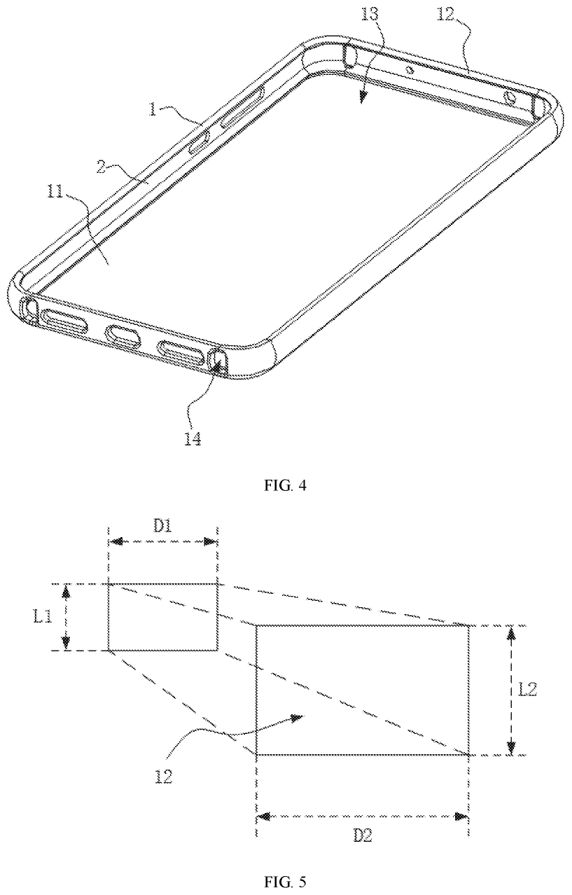

Further, as shown in FIG. 3 and FIG. 4, since the mobile phone case is provided with an antenna for transmitting and receiving signals, that is, an antenna hole 14 is disposed in an area of the main body 1 corresponding to the antenna of the mobile phone case, such that the antenna signal of the mobile phone can be transmitted through the antenna hole 14, or the antenna signal of the mobile phone can receive an external signal through the antenna hole 14, thereby realizing normal communication of the mobile phone.

Further, the antenna hole 14 is penetrated from an outer wall of the receiving cavity 13 to an inner wall of the receiving cavity 13. The antenna of the mobile phone is generally disposed on the side of the mobile phone case, that is, the antenna hole 14 is disposed on the side wall of the receiving cavity 13. It can be understood that the position of the antenna hole 14 can be set according to the setting position of the mobile phone antenna. For example, when the mobile phone antenna is disposed on the longer side of the mobile phone case, as shown in FIG. 3, the antenna hole 14 is correspondingly disposed on the longer side of the main body 1; alternatively, when the mobile phone antenna is disposed on the shorter side of the mobile phone case, as shown in FIG. 4, the antenna hole 14 is correspondingly disposed on the shorter side of the main body 1, and the number of the antenna holes 14 matches the number of the mobile phone antennas.

Further, an opening area of the antenna hole 14 on the outer wall of the receiving cavity 13 is larger than an opening area of the antenna hole 14 on the inner wall of the receiving cavity 13, that is, the antenna hole 14 is a diffused antenna hole to improve the transmission and reception of signals.

Optionally, the opening area of the antenna hole 14 on the outer wall of the receiving cavity 13 is 1.5 to 2 times the opening area of the antenna hole 14 on the inner wall of the receiving cavity 13, that is, the antenna hole 14 has a structure with a wider outside and narrow inside, such that a signal passing through the antenna hole 14 can increase a transmission area of signal. Compared with the antenna hole having a normal shape, the antenna hole 14 is arranged to have a structure with the wider outside and narrow inside, such that the propagation area of signal can be increased by 4 to 10 times to improve the transmission and reception of signals.

Further, the shape of the antenna hole 14 includes, but is not limited to, a square shape, a circular shape, or an irregular shape, and is not limited herein. Optionally, as shown in FIG. 5, the shape of the antenna hole 14 in the embodiment is square, the antenna hole 14 is positioned on the inner wall of the receiving cavity 13 and has a dimension L1 of 3 mm and D1 of 5.5 mm and the antenna hole 14 is positioned on the outer wall of the receiving cavity 13 and has a dimension L2 of 4.5 mm and D2 of 7 mm. However, in other embodiments, the values of L1, L2, D1, and D2 of the antenna hole 14 are not limited.

Further, a wall of the antenna hole 14 is curved, such that the signal can be smoothly passed through the antenna hole 14 through the curved surface structure.

Further, the first absorbing member 2 is attached to the inner side wall of the main body 1, and the first absorbing member 2 corresponding to the area of the antenna hole 14 is provided with a through hole (not shown).

In an embodiment, the flange 12 is a structure that is buckled towards the body plate, that is, the flange 12 is bent towards the receiving cavity 13. The first absorbing member 2 is disposed along a bending direction of the flange 12, and the first absorbing member 2 is matched with the shape of the flange 12, thereby after the mobile phone product is installed in the receiving cavity 13, the mobile phone product can be fastened through the structure of the first absorbing member 2 and the flange 12. Moreover, the first absorbing member 2 can be completely covered on the side of the mobile phone product, and the radiation wave absorbing effect of the first absorbing member 2 can be enhanced.

In an embodiment, the anti-radiation mobile phone case includes a microwave transmitting layer (not shown) covering the microwave transmitting layer and positioned in the receiving cavity 13. The microwave transmitting layer is disposed to transmit microwaves to the outside. In the embodiment, the microwave is an electromagnetic wave, that is, the microwave transmitting layer is disposed to transmit electromagnetic waves.

The microwave transmitting layer may be attached to the body plate 11, and the microwave transmitting layer is positioned in the receiving cavity 13, such that the microwave transmitting layer can be brought into contact with the back of the mobile phone product to better transmit electromagnetic waves of the mobile phone product, thereby maintaining normal communication of the mobile phone product. In other embodiments, the body plate 11 can be prepared by using a microwave transmitting material to form the microwave transmitting layer. The microwave transmitting material may be thermoplastic polyurethane elastomer rubber (TPU), polybutylene terephthalate (PET) plastic, etc., and is not limited herein.

Further, since the first absorbing member 2 may include a nickel iron powder and iron powder. That is, the case 1 has a nickel iron rust odor, and in order to eliminate the nickel iron rust odor, in this embodiment, the first absorbing member 2 is mixed with a fragrance, but the type of the fragrance is not limited in the present disclosure.

Further, an outer surface of the first absorbing member 2 is sprayed with a rubber oil layer to improve the retention time of fragrance of the first absorbing member 2 and enhance the user experience.

In an embodiment, since the first absorbing member 2 is reserved with respect to the back of the mobile phone product, that is, the microwave transmitting layer may also cover the reserved space of the first absorbing member 2, and the microwave transmitting layer may directly contact the back of the mobile phone product, to better transmit the electromagnetic waves of mobile phone product, thus maintaining the normal communication of mobile phone product.

Optionally, the microwave transmitting layer has a thickness of less than 2 mm. In this embodiment, the thickness of the microwave transmitting layer is 0.5 mm. However, in other embodiments, the thickness of the microwave transmission layer may be set to other values based on the above-mentioned range of values, and is not limited herein.

In an embodiment, an extending portion 21 is disposed on a side of the first absorbing member 2 away from the body plate 11, and an angle θ is formed between the extending portion 21 and the body plate 11, and the angle θ ranges from at least 20° to at most 75° to block and reduce the radiation of the mobile phone to the human body, that is, reduce the radiation from the front of the mobile phone screen to the user's brain during the communication. The extending portion 21 extends from the first absorbing member 2 towards the screen of the mobile phone product, and has an extending portion distance of at least 2 mm to at most 5 mm. The distance that the edge of the first absorbing member 2 extends towards the screen of the mobile phone product can be set to other values based on the above-mentioned range of values, which is not limited herein.

It can be understood that when the distance that the edge of the first absorbing member 2 extends towards the screen of the mobile phone product is small, the anti-radiation effect of the mobile phone case is weakened; when the distance that the edge of the first absorbing member 2 extends towards the screen of the mobile phone product is large, the edge of the mobile phone case blocks the screen of the mobile phone, which is not aesthetics. As an alternative embodiment of the present disclosure, the distance that the edge of the first absorbing member 2 extends towards the screen of the mobile phone product is 3 mm.

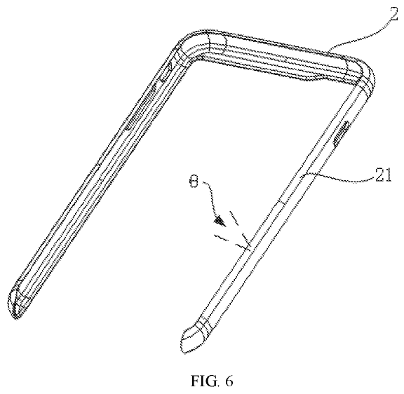

As shown in FIG. 6, an angle θ is formed between a plane where the extending portion 21 is positioned and a plane where the body plate 11 is positioned. In this embodiment, the angle θ may be 45°, thus effectively reducing the radiation from the front of the mobile phone screen to the user's brain during the communication, thereby strengthening the protection of the mobile phone case from the radiation direction of the mobile phone towards the human brain. However, in other embodiments, the angle θ can be set to other values, such as 48°, 50°, etc. based on the range of values of the angle θ, and the above effects can also be achieved, and there is no limitation here.

It can be understood that when the angle between the plane where the extending portion 21 is positioned and the plane where the body plate 11 is positioned is small, the edge of the mobile phone case blocks the screen of the mobile phone; when the angle between the plane where the extending portion 21 is positioned and the plane where the body plate 11 is positioned is large, the edge of the mobile phone case has a too large and unattractive appearance. In this embodiment, the angle θ can be selected to be 45°.

In an embodiment, since the extending portion 21 extends towards the screen of the mobile phone product, that is, part of the structure of the extending portion 21 may contact the screen and conduct electricity, so that the screen of the mobile phone is awakened. In the present embodiment, a first insulating layer (not shown) is attached to the inner sidewall of the extending portion 21, and the first insulating layer is positioned between the extending portion 21 and the screen of the mobile phone product, thereby the contact conduction between the extending portion 21 and the screen of the mobile phone product can be effectively isolated to prevent the screen of the mobile phone from being woken up.

Optionally, the first insulating layer is prepared by using an insulating material including, but not limited to, a silica gel or rubber, and is not limited herein.

Optionally, the first insulating layer has a thickness of at least 0.05 mm to at most 0.5 mm, and the thickness of the first insulating layer in the embodiment may be 0.1 mm. However, in other embodiments, the thickness of the first insulating layer may also be set to other values based on the above-mentioned range of values, and is not limited herein.

In an embodiment, the first absorbing member 2 has a thickness of at least 0.2 mm to at most 2 mm. Optionally, the thickness of the first absorbing member 2 in the embodiment may be 0.5 mm.

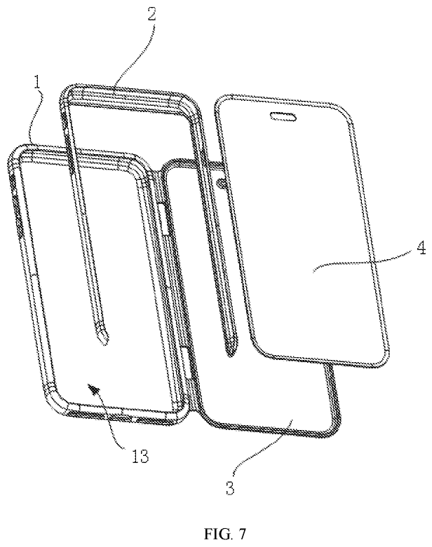

In an embodiment, as shown in FIG. 7, the anti-radiation mobile phone case further includes a cover 3, the cover 3 is rotatably connected to the main body 1, and the cover 3 is disposed to open or close the receiving cavity 13. In order to improve the anti-radiation effect of the mobile phone case, that is, during the communication, the screen of the mobile phone can be covered to absorb the electromagnetic waves generated from the screen of the mobile phone.

The cover 3 may be disposed integrally with the main body 1, for example, the cover 3 is integrally injection molded or extrusion molded with the main body 1. The cover 3 and the main body 1 are both made of a lightweight elastic material such as plastic, rubber or tempered glass to enable the cover 3 to be rotated to open or close the main body 1.

It is obvious that, in other embodiments, the cover 3 may also be disposed separately with the main body 1, the cover 3 is rotatably connected to the main body 1 by a rotating mechanism. At this time, the cover 3 and the main body 1 may be made of different materials or may be made of the same material. The rotating mechanism includes, but is not limited to, a hinge or the like, and is not limited herein.

It can be understood that, in this embodiment, the cover 3 may be disposed in four directions corresponding to the upper, lower, left and right sides of the main body 1 (only FIG. 7 shows the situation where the cover is positioned on the right side of the main body). This embodiment does not limit the positional relationship between the cover 3 and the main body 1, as long as the main body 1 can be covered by the cover 3.

In an embodiment, the anti-radiation mobile phone case further includes a second absorbing member 4, and the second absorbing member 4 is attached to a surface of the cover 3 facing the receiving cavity 13. When the second absorbing member 4 is covered by the cover 3, the second absorbing member 4 faces the screen of the mobile phone to absorb electromagnetic waves (radiation) generated from the screen of the mobile phone, thereby reducing the radiation from the mobile phone screen to the user during the communication, and effectively attenuating the radiation generated by the mobile phone product during the communication.

In order to ensure the stability of the connection between the second absorbing member 4 and the cover 3, the second absorbing member 4 and the cover 3 may be pasted using a double-sided adhesive tape with a good adhesion, to avoid that the second absorbing member 4 is easily detached from the cover 3 during the use of the anti-radiation mobile phone case. It is obvious that in other embodiments, the second absorbing member 4 may also be connected with the cover 3 by other ways, such as glue or the like, which is not limited herein.

In an embodiment, the second absorbing member 4 is a single layer structure made of wave absorbing and shielding material, or a multilayer composite structure made of at least one layer of wave absorbing and shielding material.

Optionally, the wave absorbing and shielding material may be one or more of a magnetic wave absorbing and shielding material, a metal powder wave absorbing and shielding material, a liquid alloy wave absorbing and shielding material, a composite fiber wave absorbing and shielding material, a composite rubber wave absorbing and shielding material, a composite silicone wave absorbing and shielding material, a composite resin wave absorbing and shielding material, or a composite foam wave absorbing and shielding material.

Taking the wave absorbing and shielding material as a composite silicone wave absorbing and shielding material as an example, the composite silicone wave absorbing and shielding material includes wave absorbing agent: iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder (nickel copper powder copper trichloride polymer powder), or liquid alloy powder, etc. Based on the above composite silicone wave absorbing and shielding material, the second absorbing member 4 is a single layer structure made of one of iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder, or liquid alloy powder.

Optionally, based on the above composite silicone wave absorbing and shielding material, the second absorbing member 4 is a multilayer composite structure made of at least one of iron powder, triiron tetroxide, graphite powder, nickel powder, nickel carbonyl powder, nickel carbon powder, cobalt iron alloy powder, titanium bismuth powder, cobalt strontium powder, nickel cadmium powder, tin alloy powder, magnetic copper alloy powder, or liquid alloy powder.

It can be understood that, in other embodiments, the second absorbing member 4 may be prepared by other wave absorbing and shielding material except the above composite silicone wave absorbing and shielding material, and details are not described herein again.

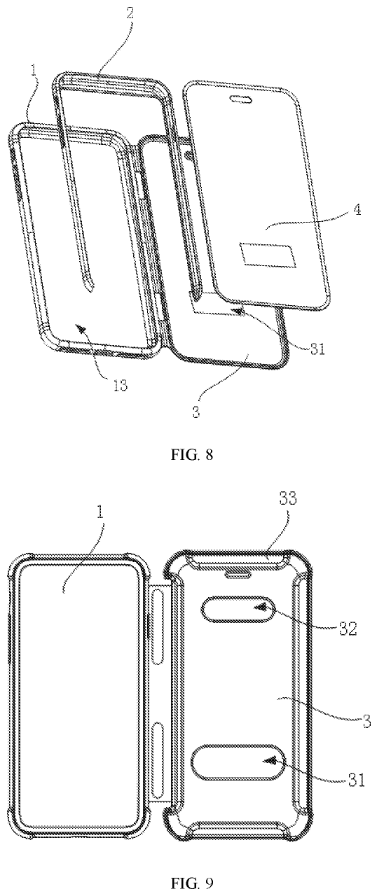

As shown in FIG. 8, in order to enable a person to dial, answer, etc. on the screen of the mobile phone when the cover 3 covers the main body 1, a display window 31 is disposed on the cover 3, and the display window 31 corresponds to a communication operation area such as dialing, answering, and the like of the mobile phone screen. Some other hole-shaped openings are also disposed on the cover 3 to implement the normal communication function of the mobile phone, which will not be described herein.

Optionally, the reserved space of the display window 31 may be a combination of one or more regular shapes and irregular shapes. For example, the reserved space may be a combination of one or more of a regular square, a regular circular arc, a regular circular shape, a regular N-sided shape (N is a positive integer greater than or equal to 3), and the like. The reserved space may also be a combination of one or more of an irregular square, an irregular circular arc, an irregular circular shape, an irregular N-sided shape (N is a positive integer greater than or equal to 3), and the like, and is not limited thereto.

It can be understood that, the area of the display window 31 should be adapted to the area of the communication operation such as dialing, answering, etc. on the screen of the mobile phone, and the size is moderate. When the area of the display window 31 is large, the anti-radiation effect of the mobile phone case is weakened.

In an embodiment, since the second absorbing member 4 is disposed towards the screen of the mobile phone product, when the second absorbing member 4is covered by the cover 3, the second absorbing member 4 may contact the screen of the mobile phone, that is, a part of the structure of the second absorbing member 4 may contact the screen and conduct electricity, so that the screen of the mobile phone is awakened. In this embodiment, a side of the second absorbing member 4 facing away from the cover 3 is attached by a second insulating layer (not shown), and the second insulating layer is positioned between the second absorbing member 4 and the screen of the mobile phone product, thereby the contact conduction between the second absorbing member 4 and the screen of the mobile phone product can be effectively isolated to prevent the screen of the mobile phone from being woken up.

Optionally, the second insulating layer is prepared by using an insulating material including, but not limited to, a silica gel or rubber, and is not limited herein.

Optionally, the second insulating layer has a thickness of at least 0.05 mm to at most 0.5 mm, and the thickness of the second insulating layer in the embodiment may be 0.1 mm. However, in other embodiments, the thickness of the second insulating layer may also be set to other values based on the above-mentioned range of values, and is not limited herein.

In another embodiment, as shown in FIGS. 9 to 11, the periphery of the cover 3 is provided with a cladding edge 33, and the cladding edge 33 is disposed to wrap around the side of the mobile phone product, so that the radiation wave generated from the side of the mobile phone is weakened. The cladding edge 33 and the second absorbing member 4 are made of the same material, that is, made of the wave absorbing and shielding material, the details refer to the description of the above embodiments, and are not described herein again.

Optionally, the first absorbing member 2 corresponding to the headphone hole, the charging hole, the speaker hole and the like of the main body 1 may also be provided with corresponding holes (see FIGS. 3 to 4). However, the bottom end of the first absorbing member 2 may also be provided as an open structure. As shown in FIGS. 2 and 6 to 8, the bottom end of the first absorbing member 2 omits the corresponding hole structure.

In addition, the cover 3 is further provided with a status display window 32, which is arranged to display the state of the mobile phone.

It can be understood that, in this embodiment, the cover 3 may be disposed in four directions corresponding to the upper, lower, left and right sides of the main body 1 (only FIG. 9 shows the situation where the cover is positioned on the right side of the main body). This embodiment does not limit the positional relationship between the cover 3 and the main body 1, as long as the main body 1 can be covered by the cover 3, the cladding edge 33 can be wrapped around the side of the mobile phone.

Based on the above embodiments, tested by an authoritative inspection agency, the anti-radiation mobile phone case of the present disclosure takes YD-T1644.1-2007 (Human exposure to ratio frequency fields from hand-held and body-mounted wireless communication devices-Human models, instrumentation and procedures) as the test standard with the frequency band of WCDMA BAND1. When taking 10 g of electromagnetic as an example, the specific absorption rate (SAR) (W/Kg) is 98.76% and when taking lg of electromagnetic as an example, the specific absorption rate (SAR) (W/Kg) is 99.22%.

In the present disclosure, the anti-radiation mobile phone case includes a main body 1 and a first absorbing member 2, the main body 1 is provided with a body plate 11 and a flange 12 disposed at a periphery of the body plate 11, and the body plate 11 is enclosed with the flange 12 to form a receiving cavity 13. The first absorbing member 2 is attached onto an inner side wall of the flange 12, and a space of the body plate corresponding to the first absorbing member is reserved.

The first absorbing member 2 is a single layer structure made of wave absorbing and shielding material, or a multilayer composite structure made of at least one layer of wave absorbing and shielding material. As such, in the technical solution of the present disclosure, the first absorbing member 2 is configured to absorb the radiation and the space of the body plate corresponding to the first absorbing member is reserved, to ensure normal communication of the mobile phone, thereby effectively attenuating the radiation generated by the mobile phone during the poor signal strength or the communication.

The above are only the preferred embodiments of the present disclosure and are not therefore limiting the scope of the present disclosure. Any equivalent change made by using the contents of the present specification and drawings, or directly or indirectly applied in other related technical fields, shall be included in the protection scope of the present disclosure.

What is claimed is:

1. An anti-radiation mobile phone case, comprising:
a main body, wherein the main body is provided with a body plate and a flange disposed at a periphery of the body plate; the body plate is enclosed with the flange to form a receiving cavity; and
a first absorbing member, wherein the first absorbing member is attached onto an inner side wall of the flange, and a space of the body plate corresponding to the first absorbing member is reserved,
wherein the first absorbing member is a single layer made of wave absorbing and shielding material, or a multilayer composite made of at least one layer of wave absorbing and shielding material.

2. The anti-radiation mobile phone case of claim 1, wherein the anti-radiation mobile phone case further comprises an antenna hole, and the antenna hole is penetrated from an outer wall of the receiving cavity to an inner wall of the receiving cavity.

3. The anti-radiation mobile phone case of claim 2, wherein an opening area of the antenna hole on the outer wall of the receiving cavity is larger than an opening area of the antenna hole on the inner wall of the receiving cavity.

4. The anti-radiation mobile phone case of claim 3, wherein a wall of the antenna hole is curved.

5. The anti-radiation mobile phone case of claim 2, wherein the first absorbing member corresponding to an area of the antenna hole is provided with a through hole.

6. The anti-radiation mobile phone case of claim 1, wherein the first absorbing member is mixed with a fragrance.

7. The anti-radiation mobile phone case of claim 6, wherein an outer surface of the first absorbing member is sprayed with a rubber oil layer.

8. The anti-radiation mobile phone case of claim 1, wherein the first absorbing member is disposed along a bending direction of the flange.

9. The anti-radiation mobile phone case of claim 1, wherein the anti-radiation mobile phone case comprises a microwave transmitting layer covering the body plate and positioned in the receiving cavity; or
the microwave transmitting layer is configured to cover a reserved space for the first absorbing member.

10. The anti-radiation mobile phone case of claim 1, wherein an extending portion is disposed on a side of the first absorbing member away from the body plate, and an angle θ is formed between the extending portion and the body plate, and the angle θ ranges from at least 20° to at most 75°.

11. The anti-radiation mobile phone case of claim 10, wherein a first insulating layer is attached to an inner side wall of the extending portion.

12. The anti-radiation mobile phone case of claim 1, wherein the first absorbing member has a thickness of at least 0.2 mm to at most 2 mm.

13. The anti-radiation mobile phone case of claim 1, wherein the anti-radiation mobile phone case further comprises a cover, the cover is rotatably connected to the main body, and the cover is disposed to open or close the receiving cavity.

14. The anti-radiation mobile phone case of claim 13, wherein the anti-radiation mobile phone case further comprises a second absorbing member attached to a surface of the cover facing the receiving cavity.

15. The anti-radiation mobile phone case of claim 13, wherein a display window is disposed on the cover.

16. The anti-radiation mobile phone case of claim 14, wherein a side of the second absorbing member away from the cover is attached by a second insulating layer.
